(19) United States
(12) Patent Application Publication
(10) Pub. No.: US 2025/0115720 A1
(43) Pub. Date: Apr. 10, 2025

(54) HYPERBRANCHED POLYCAPROLACTONE-POLYLACTIC ACID COPOLYMER (PCL-PLA), PREPARATION METHOD AND SOLID ELECTROLYTE APPLICATION THEREOF

(71) Applicant: CHINA UNIVERSITY OF GEOSCIENCES (WUHAN), Wuhan (CN)

(72) Inventors: Rui MA, Wuhan (CN); Hongyun JIN, Wuhan (CN); Limin YOU, Wuhan (CN); Qian SHAN, Wuhan (CN); Yunjie ZHANG, Wuhan (CN); Zhuoxiong HUANG, Wuhan (CN)

(73) Assignee: CHINA UNIVERSITY OF GEOSCIENCES (WUHAN), Wuhan (CN)

(21) Appl. No.: 18/987,843

(22) Filed: Dec. 19, 2024

(30) Foreign Application Priority Data
Dec. 20, 2023 (CN) 202311765192.0

(51) Int. Cl. C08G 83/00; C08G 63/91; H01M 10/0565

(52) U.S. Cl. CPC C08G 83/005; C08G 63/912; H01M 10/0565; H01M 2300/0082

(57) ABSTRACT

The present disclosure provides a hyperbranched polycaprolactone-polylactic acid copolymer (PCL-PLA), preparation method and solid electrolyte application thereof, and belongs to the technical field of polymer synthesis. The copolymer is prepared as follows: an intermediate of dihydroxymethyl propionamido-terminated polylactic acid (PLA-DMPA) is synthesized with amino-terminated polylactic acid (PLA) and 2,2-dihydroxymethylpropionic acid as starting materials, and then the PLA-DMPA is subjected to polymerization with ε-caprolactone. PCL and PLA are combined through chemical bonds. The polymer with a hyperbranched structure has many free terminal groups, which can provide increased lithium-ion transmission channels and facilitates the increase of ionic conductivity. The presence of PLA reduces the crystallinity of PCL, and is conducive to the movement of chain segments of the polymer, thereby improving the transport capacity of lithium ions in the polymer. The copolymer exhibits better cycling performance and electrochemical stability than a pure PCL electrolyte.

### CROSS-REFERENCE TO RELATED APPLICATIONS

This application claims priority to Chinese Patent Application No. 202311765192.0 with a filing date of Dec. 20, 2023. The content of the aforementioned application, including any intervening amendments thereto, is incorporated herein by reference.

### TECHNICAL FIELD

The present disclosure belongs to the technical field of synthesis of high polymers, and specifically relates to a hyperbranched polycaprolactone-polylactic acid copolymer (PCL-PLA), preparation method and solid electrolyte application thereof.

### BACKGROUND

Since the beginning of the 20th century, the major energy in China has been supplied mainly by fossil fuels, which have a heavy impact on the environment. Thus, the research on new green and sustainable energy has been put on the agenda. The invention of lithium batteries is very important for the policy of “carbon neutrality and peak carbon dioxide emissions”. Lithium batteries are the optimal energy storage devices due to advantages such as high energy density, prominent cycling efficiency, eco-friendliness, and sustainability. In particular, liquid organic batteries are the most common lithium batteries. The current large and small electric devices such as new energy vehicles, mobile phones, and laptops are inseparable from lithium batteries.

However, the outstanding lithium batteries have potential safety hazards. The “Samsung smartphone explosion” events many years ago and the “burning Tesla” events in recent years have made it difficult for the public to believe in the safety of batteries. Liquid lithium-ion electrolyte-based batteries are generally at the risk of combustion and explosion at high temperatures, which greatly limits the development of liquid lithium-ion electrolyte-based batteries in power batteries and energy storage batteries.

As a result, solid polymer electrolytes emerge accordingly. Due to advantages such as extremely-high safety, chemical stability, and no bulging or leakage in the PACK, the solid polymer electrolytes are the direction of electrolyte development in the future. However, the research on solid polymer electrolytes is not mature enough to allow the commercialization. This is mainly because most polymer structures can hardly be electrically conductive and only some special polymers can be modified to enable the electrical conductivity.

As a polymer material, polycaprolactone (PCL) has become one of the most promising new electrolyte materials due to excellent characteristics such as high stability for lithium, wide electrochemical stability window, low cost, and simple preparation. However, PCL is a semi-crystalline polymer with high crystallinity at room temperature, which causes the blockage of chain segment movement and the low ionic conductivity. Moreover, the commercialized PCL has a linear molecular chain structure, which is not conducive to the movement of lithium ions in the polymer and limits the application of PCL as an electrolyte. Thus, PCL needs to be modified. The traditional physical blending modification is to make two or more components combined through weak van der Waals forces. However, the traditional physical blending modification may lead to the deterioration of performance due to uneven dispersion, such as cracking, poor heat resistance, easy short circuit, and other defects.

### SUMMARY OF PRESENT INVENTION

An objective of the present disclosure is to provide a PCL-PLA preparation method and solid electrolyte application thereof in view of the above-mentioned deficiencies in the prior art. The PCL-PLA can provide increased lithium-ion transmission channels and is conducive to the increase of ionic conductivity.

To achieve the above objective, the present disclosure adopts the following technical solutions:

A first objective of the present disclosure is to provide PCL-PLA with a structure shown in the following formula I:

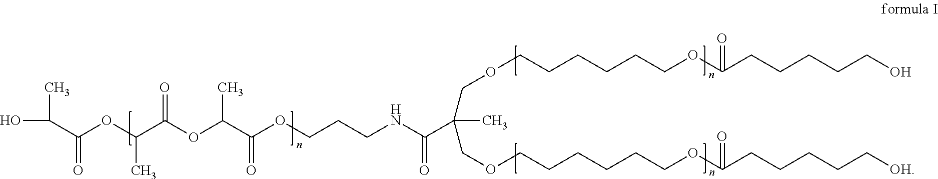

A second objective of the present disclosure is to provide a preparation method of the PCL-PLA, including the following specific steps:
S1, dissolving amino-terminated polylactic acid (PLA) and 2,2-dihydroxymethylpropionic acid in a solvent, adding a catalyst, and conducting a reaction to produce a mixture A;
S2, subjecting the mixture A obtained in the S1 to water-washing, and precipitating with a first precipitating agent to produce dihydroxymethyl propionamido-terminated polylactic acid (PLA-DMPA);
S3, subjecting the PLA-DMPA obtained in the S2 to polymerization with ε-caprolactone in a nitrogen atmosphere in the presence of a catalyst to produce a mixture B; and
S4, dissolving the mixture B obtained in the S3, and precipitating with a second precipitating agent to produce the PCL-PLA.

Further, in the S1, the solvent is dichloromethane, and the catalyst is 1-hydroxybenzotriazole (HOBt) and 1-ethyl-(3-dimethylaminopropyl) carbodiimide hydrochloride (EDCI).

Further, a molar ratio of the amino-terminated PLA to the 2,2-dihydroxymethylpropionic acid is 1:(0.9-1.1), a molar ratio of the HOBt to the EDCI is 1:(0.9-1.1), and a molar ratio of the catalyst to the 2,2-dihydroxymethylpropionic acid is 3:(1.5-2.5).

Further, in the S1, the reaction is conducted at 20° C. to 40° C. for 8 h to 12 h.

Further, in the S3, the catalyst is stannous isocaprylate, a mass ratio of the PLA-DMPA to the ε-caprolactone is 1:(2-9), and a mass of the catalyst is 0.10% to 0.40% of a mass of the &-caprolactone.

Further, in the S3, the polymerization is conducted at 140° C. to 150° C. for 5 h to 6 h.

Further, in the S2, a solvent for the water-washing is distilled water, and the first precipitating agent is methanol; and in the S4, a solvent for the dissolving is dichloromethane, and the second precipitating agent is methanol.

A third objective of the present disclosure is to provide an electrolyte including the PCL-PLA described above.

A fourth objective of the present disclosure is to provide an electrolyte-based battery, including an anode, a cathode, and an electrically-conductive electrolyte, where the electrically-conductive electrolyte includes the electrolyte described above.

Compared with the prior art, the present disclosure has the following beneficial effects:
(1) The PCL-PLA provided by the present disclosure is prepared as follows: an intermediate of PLA-DMPA is synthesized with amino-terminated PLA and 2,2-dihydroxymethylpropionic acid as starting materials, and then the PLA-DMPA is subjected to polymerization with ε-caprolactone to produce the PCL-PLA. PCL and PLA are combined through chemical bonds, and these polymers have homogeneous structures. Both PCL and PLA are biodegradable polymers, which facilitates the recycling and is in line with the eco-friendly and sustainable development.
(2) The PCL-PLA provided by the present disclosure exhibits better cycling performance and electrochemical stability than a pure PCL electrolyte.
(3) In addition, the polymer with a hyperbranched structure has many free terminal groups, which can provide increased lithium-ion transmission channels and facilitates the increase of ionic conductivity.
(4) The presence of PLA reduces the crystallinity of PCL, which facilitates the movement of polymer chains, thereby increasing the transport capacity of lithium ions.

### BRIEF DESCRIPTION OF THE DRAWINGS

FIG. 1 shows a synthesis route of the hyperbranched PCL-PLA copolymer of the present disclosure;

FIG. 2 is a schematic diagram of lithium ion movement in the hyperbranched PCL-PLA copolymer prepared by the present disclosure;

FIG. 3 shows a hydrogen nuclear magnetic resonance (HNMR) spectrum of the intermediate PLA-DMPA in the preparation method of the hyperbranched PCL-PLA copolymer of the present disclosure;

FIG. 4 shows an HNMR spectrum of the hyperbranched PCL-PLA copolymer of the present disclosure;

FIG. 5 shows differential scanning calorimetry (DSC) curves of hyperbranched PCL-PLA copolymers prepared in different ratios in the present disclosure;

FIG. 6a and FIG. 6b show dynamic mechanical analysis (DMA) curves of hyperbranched PCL-PLA copolymers prepared in different ratios in the present disclosure; and

FIG. 7 shows ionic conductivities of electrolyte-based batteries prepared with the hyperbranched PCL-PLA copolymers of the present disclosure.

### DETAILED DESCRIPTION OF THE EMBODIMENTS

To make the objectives, technical solutions, and advantages of the present disclosure clear, the embodiments of the present disclosure are described below in detail. Examples of the embodiments are shown in the accompanying drawings. The same or similar numerals represent the same or similar elements or elements having the same or similar functions throughout the specification. The embodiments described below with reference to the accompanying drawings are exemplary. These embodiments are merely provided to explain the present disclosure, and should not be construed as a limitation to the present disclosure.

In the present disclosure, 2,2-dihydroxymethylpropionic acid is also called 2,2-bis(hydroxymethyl) propionic acid, 1-hydroxybenzotriazole is abbreviated as HOBt, 1-ethyl-(3-dimethylaminopropyl) carbodiimide hydrochloride is abbreviated as EDCI, stannous isocaprylate is abbreviated as Sn(Oct)₂, polycaprolactone is abbreviated as PCL, polylactic acid is abbreviated as PLA, dihydroxymethyl propionamido-terminated polylactic acid is abbreviated as PLA-DMPA, and a hyperbranched polycaprolactone-polylactic acid copolymer is abbreviated as PCL-PLA.

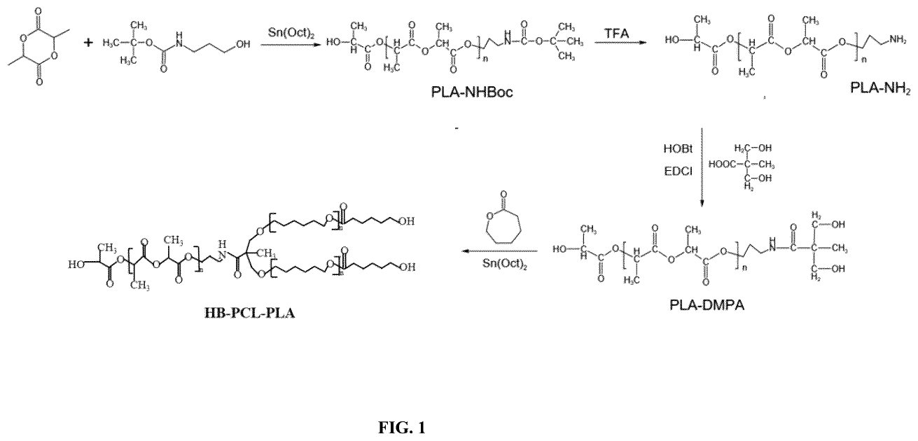

FIG. 1 shows a synthesis route of the PCL-PLA of the present disclosure. The following embodiments are implemented in accordance with the synthesis route, and specific synthesis steps are as follows:
(1) Amino-terminated PLA and 2,2-dihydroxymethylpropionic acid are dissolved with dichloromethane, then HOBt and EDCI are added, and a reaction is conducted at 20° C. to 40° C. for 8 h to 12 h to produce a mixture A. A molar ratio of the amino-terminated PLA to the 2,2-dihydroxymethylpropionic acid is 1:(0.9-1.1), a molar ratio of the HOBt to the EDCI is 1:(0.9-1.1), and a molar ratio of the catalyst to the 2,2-dihydroxymethylpropionic acid is 3:(1.5-2.5).
(2) The mixture A is washed with water, and then subjected to precipitation with a first precipitating agent to produce PLA-DMPA.
(3) The PLA-DMPA is subjected to polymerization with ε-caprolactone in a nitrogen atmosphere in the presence of stannous isocaprylate, and the polymerization is conducted at 140° C. to 160° C. for 5 h to 6 h to produce a mixture B. A mass ratio of the PLA-DMPA to the ε-caprolactone is 1:(2-9), and an amount of the stannous isocaprylate added is 0.10% to 0.40% of a mass of the ε-caprolactone.
(4) The mixture B is dissolved and subjected to precipitation with methanol to produce the PCL-PLA.

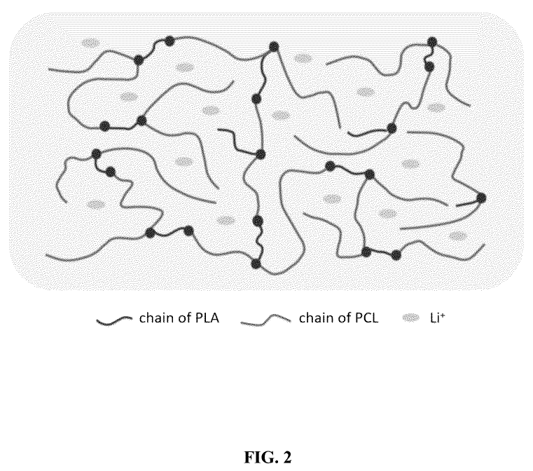

FIG. 2 is a schematic diagram of lithium ion movement in the PCL-PLA. Through the above synthesis method of new PCL-PLA, PCL-PLA with a hyperbranched structure is successfully designed. The presence of the hyperbranched structure provides increased lithium-ion transmission channels, and greatly enhances the molecular chain movement in the polymer, which makes a corresponding polymer electrolyte have high ionic conductivity.

In some embodiments, the PCL-PLA of the present disclosure may be used alone as an electrolyte, and can also be used as a raw material for an electrolyte material.

### Example 1

In this example, a preparation method of PCL-PLA-10 was provided.

Specific steps were as follows:
(1) Synthesis of PLA-DMPA: 2 g (0.3 mmol) of PLA-NH2 and 0.04 g (0.3 mmol) of 2,2-dihydroxymethylpropionic acid were added successively to a round-bottomed flask, and dichloromethane was added for dissolution. After the dissolution was completed, 0.06 g (0.45 mmol) of HOBt and 0.086 g (0.45 mmol) of EDCI were added successively to the round-bottomed flask, and a reaction was conducted for 10 h. Distilled water was added for water-washing, and precipitation was conducted with methanol to produce PLA-DMPA.
(2) Synthesis of a hyperbranched copolymer: 10 wt % of PLA-DMPA as an initiating macromolecule, ¿-caprolactone, and 0.2 wt % of Sn(Oct)₂ were added successively to a round-bottomed flask and heated to 150° C. to allow polymerization for 3 h in a nitrogen environment. Dichloromethane was added for dissolution, and precipitation was conducted with methanol to produce the PCL-PLA-10.

### Example 2

In this example, a preparation method of PCL-PLA-15 was provided.

Specific steps were as follows:
(1) Synthesis of PLA-DMPA: 2 g (0.3 mmol) of PLA-NH2 and 0.04 g (0.3 mmol) of 2,2-dihydroxymethylpropionic acid were added successively to a round-bottomed flask, and dichloromethane was added for dissolution. After the dissolution was completed, 0.06 g (0.45 mmol) of HOBt and 0.086 g (0.45 mmol) of EDCI were added successively to the round-bottomed flask, and a reaction was conducted for 10 h. Distilled water was added for water-washing, and precipitation was conducted with methanol to produce PLA-DMPA.
(2) Synthesis of a hyperbranched copolymer: 15 wt % of PLA-DMPA as an initiating macromolecule, ε-caprolactone, and 0.2 wt % of Sn(Oct)₂ were added successively to a round-bottomed flask and heated to 150° C. to allow polymerization for 3 h in a nitrogen environment. Dichloromethane was added for dissolution, and precipitation was conducted with methanol to produce the PCL-PLA-15.

### Example 3

In this example, a preparation method of PCL-PLA-20 was provided.

Specific steps were as follows:
(1) Synthesis of PLA-DMPA: 2 g (0.3 mmol) of PLA-NH2 and 0.04 g (0.3 mmol) of 2,2-dihydroxymethylpropionic acid were added successively to a round-bottomed flask, and dichloromethane was added for dissolution. After the dissolution was completed, 0.06 g (0.45 mmol) of HOBt and 0.086 g (0.45 mmol) of EDCI were added successively to the round-bottomed flask, and a reaction was conducted for 10 h. Distilled water was added for water-washing, and precipitation was conducted with methanol to produce PLA-DMPA.
(2) Synthesis of a hyperbranched copolymer: 20 wt % of PLA-DMPA as an initiating macromolecule, ε-caprolactone, and 0.2 wt % of Sn(Oct)₂ were added successively to a round-bottomed flask and heated to 150° C. to allow polymerization for 3 h in a nitrogen environment. Dichloromethane was added for dissolution, and precipitation was conducted with methanol to produce the PCL-PLA-20.

### Example 4

In this example, a preparation method of PCL-PLA-25 was provided.

Specific steps were as follows:
(1) Synthesis of PLA-DMPA: 2 g (0.3 mmol) of PLA-NH2 and 0.04 g (0.3 mmol) of 2,2-dihydroxymethylpropionic acid were added successively to a round-bottomed flask, and dichloromethane was added for dissolution. After the dissolution was completed, 0.06 g (0.45 mmol) of HOBt and 0.086 g (0.45 mmol) of EDCI were added successively to the round-bottomed flask, and a reaction was conducted for 10 h. Distilled water was added for water-washing, and precipitation was conducted with methanol to produce PLA-DMPA.
(2) Synthesis of a hyperbranched copolymer: 25 wt % of PLA-DMPA as an initiating macromolecule, ε-caprolactone, and 0.2 wt % of Sn(Oct)₂ were added successively to a round-bottomed flask and heated to 150° C. to allow polymerization for 3 h in a nitrogen environment. Dichloromethane was added for dissolution, and precipitation was conducted with methanol to produce the PCL-PLA-25.

### Example 5

In this example, a preparation method of PCL-PLA-30 was provided.

Specific steps were as follows:
(1) Synthesis of PLA-DMPA: 2 g (0.3 mmol) of PLA-NH2 and 0.04 g (0.3 mmol) of 2,2-dihydroxymethylpropionic acid were added successively to a round-bottomed flask, and dichloromethane was added for dissolution. After the dissolution was completed, 0.06 g (0.45 mmol) of HOBt and 0.086 g (0.45 mmol) of EDCI were added successively to the round-bottomed flask, and a reaction was conducted for 10 h. Distilled water was added for water-washing, and precipitation was conducted with methanol to produce PLA-DMPA.
(2) Synthesis of a hyperbranched copolymer: 30 wt % of PLA-DMPA as an initiating macromolecule, ε-caprolactone, and 0.2 wt % of Sn(Oct)₂ were added successively to a round-bottomed flask and heated to 150° C. to allow polymerization for 3 h in a nitrogen environment. Dichloromethane was added for dissolution, and precipitation was conducted with methanol to produce the PCL-PLA-30.

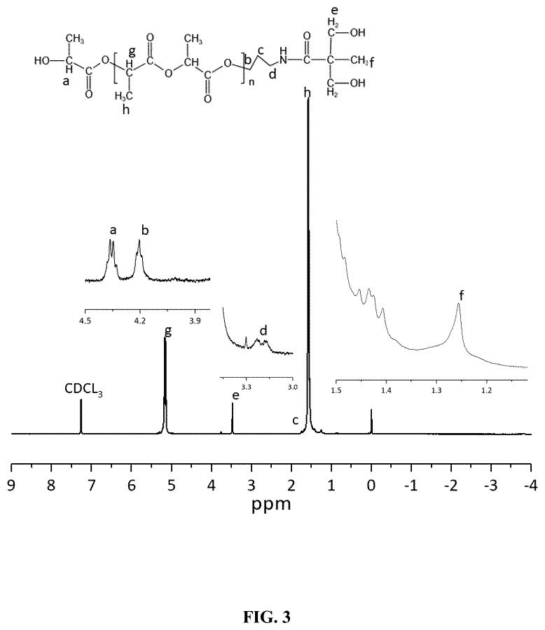

FIG. 3 shows an HNMR spectrum of the intermediate PLA-DMPA in the preparation method of PCL-PLA. It can be seen that —CH₃ and —CH₂— signal peaks of terminal hydroxyl appear at 1.26 ppm and 3.50 ppm, respectively, and a —CH₂— signal peak of amido appears at 3.25 ppm, indicating that —COOH in the DMPA structure and —NH₂ in a terminal group of PLA-NH₂ are successfully modified to produce PLA-DMPA.

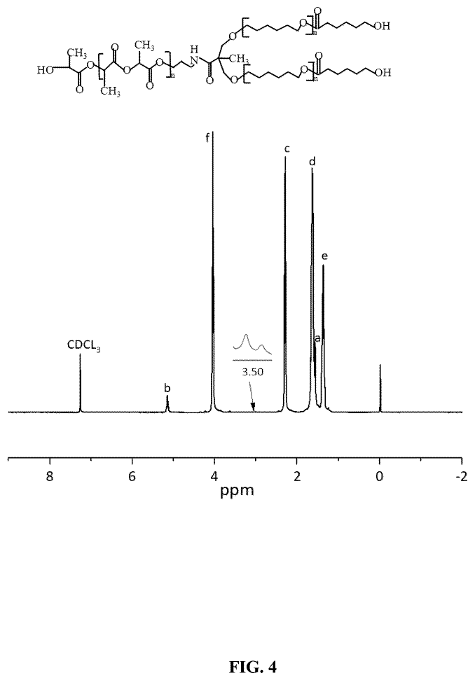

FIG. 4 shows an HNMR spectrum of the PCL-PLA. In this figure, a and b are PLA chain segment signals, and c, d, e, and f are PCL chain segment signals, indicating that the caprolactone monomer is successfully subjected to ring-opening polymerization in the presence of PLA. An intensity of a —CH₂— signal peak for hydroxyl at 3.50 ppm is much weaker than an intensity of the corresponding signal peak at 3.50 ppm in FIG. 3, indicating that the polymerization of the ε-CL monomer is initiated by terminal-OH of PLA-DMPA and the number of —OH groups decreases. In addition, it can be calculated that a ratio of an integral area at e to an integral area at a in FIG. 3 is about 0.098, and a ratio of peak integral areas at the two positions in FIG. 4 is 0.0157. By calculating (0.098-0.0157)/0.098, a utilization rate of hydroxyl on-DMPA can be determined roughly as 83.7%.

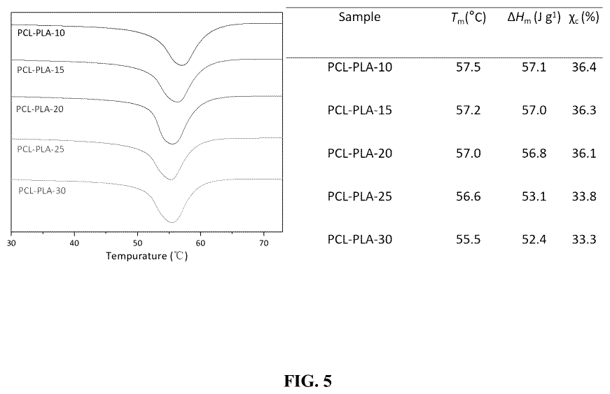

FIG. 5 shows DSC data of PCL-PLA copolymers prepared in different ratios in Examples 1 to 5. It can be seen that, with the increase of an addition amount of PLA, the crystallinity of a system decreases, indicating that a crystalline region proportion of PCL decreases and the motility of polymer chains is improved.

### Comparative Example 1

In this comparative example, an electrolyte PCL was provided.

5 g of a ε-CL monomer and 0.2 wt % of Sn(Oct)₂ were added successively to a round-bottomed flask and heated to 150° C. to allow polymerization for 3 h in a nitrogen environment. Dichloromethane was added for dissolution, and precipitation was conducted with methanol to produce pure PCL.

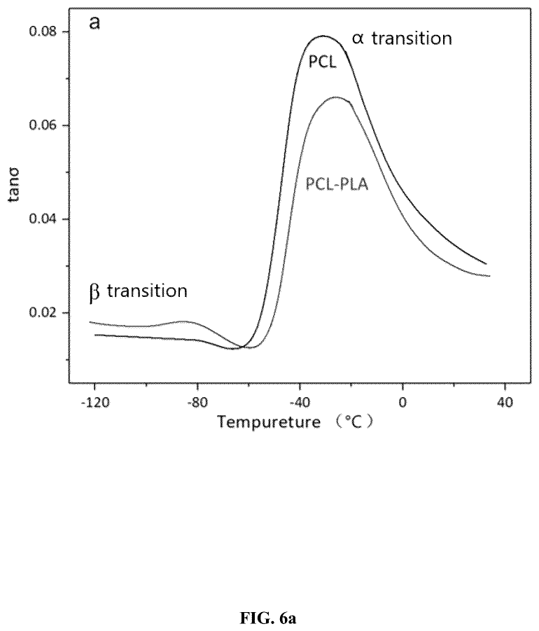

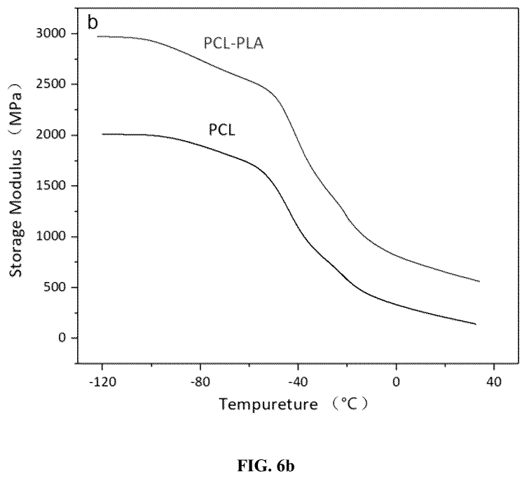

FIG. 6a shows DMA data of PCL-PLA copolymers prepared in different ratios in Examples 1 to 5. It can be seen that, compared with the pure PCL, the PCL-PLA undergoes β transition at a low temperature, indicating the presence of a hyperbranched structure. In addition, the PCL-PLA has a lower loss factor than the pure PCL, indicating the excellent motility of chain segments in the PCL-PLA.

As shown in FIG. 6b, the PCL-PLA has a high storage modulus, indicating that the PCL-PLA can exhibit prominent thermomechanical performance when used as a solid electrolyte.

### Example 6

In this example, electrolyte-based batteries were provided.

The prepared pure PCL, PCL-PLA-10, PCL-PLA-15, PCL-PLA-20, PCL-PLA-25, and PCL-PLA-30 each were dissolved in dimethyl carbonate (DMC), 20 wt % of a lithium salt LiTFSI and 20 wt % of nano-Al₂O₃were added as fillers, and stirring was fully conducted to produce homogeneous solutions. The homogeneous solutions each were tape-casted for film formation, and then allowed to stand for a specified period of time until DMC was volatilized to produce solid electrolyte membranes. Finally, the solid electrolyte membranes each were used to assemble a button battery in an order of negative electrode cover-shrapnel-gasket-electrolyte membrane-gasket-positive electrode cover.

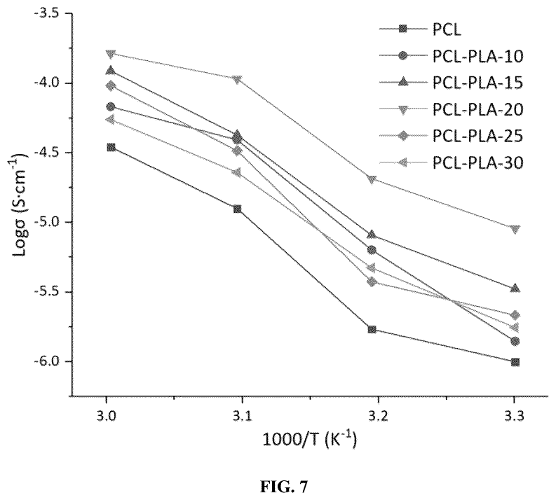

FIG. 7 shows ionic conductivities of electrolyte-based batteries prepared with the PCL-PLA copolymers in different ratios in Examples 1 to 5. It can be seen from this figure that an electrolyte-based battery prepared with the PCL-PLA-20 has maximum ionic conductivity. That is, PCL-PLA prepared with a PLA addition amount of 20 wt % has the optimal electrical conductivity.

What is not mentioned above can be acquired in the prior art.

Although some specific embodiments of the present disclosure have been described in detail by way of examples, those skilled in the art will appreciate that the above examples are provided for illustration only and not for limiting the scope of the present disclosure. A person skilled in the art can make various modifications or supplements to the specific embodiments described or replace them in a similar manner, but it may not depart from the direction of the present disclosure or the scope defined by the appended claims. Those skilled in the art should understand that any modification, equivalent replacement, and improvement that are made to the above embodiments according to the technical essence of the present disclosure shall be included in the protection scope of the present disclosure.

What is claimed is:

1. A hyperbranched polycaprolactone-polylactic acid copolymer (PCL-PLA) with a structure shown in the following formula I:

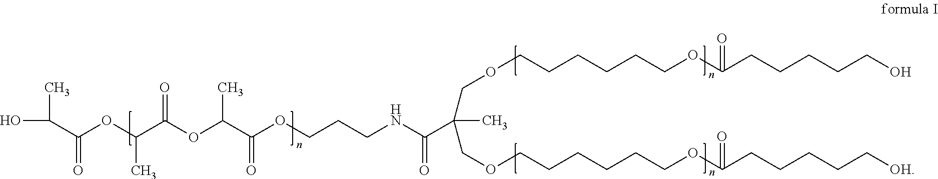

2. A preparation method of the PCL-PLA according to claim 1, comprising the following specific steps:
S1, dissolving amino-terminated polylactic acid (PLA) and 2,2-dihydroxymethylpropionic acid in a solvent, adding a catalyst, and conducting a reaction to produce a mixture A;
S2, subjecting the mixture A obtained to water-washing, and precipitating with a first precipitating agent to produce dihydroxymethyl propionamido-terminated polylactic acid (PLA-DMPA);
S3, subjecting the PLA-DMPA obtained to polymerization with ε-caprolactone in a nitrogen atmosphere in presence of a catalyst to produce a mixture B; and
S4, dissolving the mixture B obtained, and precipitating with a second precipitating agent to produce the PCL-PLA.

3. The preparation method according to claim 2, wherein in the S1, the solvent is dichloromethane, and the catalyst is 1-hydroxybenzotriazole (HOBt) and 1-ethyl-(3-dimethylaminopropyl) carbodiimide hydrochloride (EDCI).

4. The preparation method according to claim 3, wherein a molar ratio of the amino-terminated PLA to the 2,2-dihydroxymethylpropionic acid is 1:(0.9-1.1), a molar ratio of the HOBt to the EDCI is 1:(0.9-1.1), and a molar ratio of the catalyst to the 2,2-dihydroxymethylpropionic acid is 3:(1.5-2.5).

5. The preparation method according to claim 4, wherein in the S1, the reaction is conducted at 20° C. to 40° C. for 8 h to 12 h.

6. The preparation method according to claim 2, wherein in the S3, the catalyst is stannous isocaprylate, a mass ratio of the PLA-DMPA to the ε-caprolactone is 1:(2-9), and a mass of the catalyst is 0.10% to 0.40% of a mass of the ε-caprolactone.

7. The preparation method according to claim 6, wherein in the S3, the polymerization is conducted at 140° C. to 160° C. for 5 h to 6 h.

8. The preparation method according to claim 2, wherein in the S2, a solvent for the water-washing is distilled water, and the first precipitating agent is methanol; and in the S4, a solvent for the dissolving is dichloromethane, and the second precipitating agent is methanol.

9. An electrolyte comprising the PCL-PLA according to claim 1.

10. An electrolyte-based battery, comprising an anode, a cathode, and an electrically-conductive electrolyte, wherein the electrically-conductive electrolyte comprises the electrolyte according to claim 9.
